(19) United States
(12) Patent Application Publication
(10) Pub. No.: US 2013/0069837 A1
(43) Pub. Date: Mar. 21, 2013

(54) DIRECTIVE ANTENNA WITH ISOLATION FEATURE

(71) Applicants: Randell Cozzolino, Phoenix, AZ (US); Ricky Chair, Phoenix, AZ (US)

(72) Inventors: Randell Cozzolino, Phoenix, AZ (US); Ricky Chair, Phoenix, AZ (US)

(73) Assignee: GALTRONICS CORPORATION LTD., Tiberias (IL)

(21) Appl. No.: 13/699,384

(22) PCT Filed: Jun. 9, 2011
(86) PCT No.: PCT/IL11/00459

§ 371 Date: Nov. 21, 2012

Related U.S. Application Data
(60) Provisional application No. 61/352,968, filed on Jun. 9, 2010.

(51) Int. Cl. H01Q 9/16; H01Q 21/00; H01Q 13/10

(52) U.S. Cl. 343/727

(57) ABSTRACT

An antenna including a reflector formed by a ground plane, the ground plane having a notch therein, at least one parasitic director offset from the ground plane and a driven element formed by a dipole antenna coupled to the ground plane in proximity to the notch and located between the at least one parasitic director and an edge of the ground plane.

### REFERENCE TO RELATED APPLICATIONS

Reference is hereby made to U.S. Provisional Patent Application 61/352,968, entitled EMBEDDED DIRECTIVE ANTENNA WITH ISOLATION FEATURES, filed Jun. 9, 2011, the disclosure of which is hereby incorporated by reference and priority of which is hereby claimed pursuant to 37 CFR 1.78(a)(4) and (5)(i).

### FIELD OF THE INVENTION

The present invention relates generally to antennas and more particularly to directive antennas for use in wireless devices.

### BACKGROUND OF THE INVENTION

The following patent documents are believed to represent the current state of the art:
U.S. Pat. Nos. 5,008,681; 5,220,335; 5,712,643; 5,913,549; 6,025,811; 6,046,703; 6,326,922; 6,483,476; 7,015,860 and 7,202,824.

### SUMMARY OF THE INVENTION

The present invention seeks to provide an improved directive antenna with an isolation feature, for use in wireless communication devices.

There is thus provided in accordance with a preferred embodiment of the present invention an antenna including a reflector formed by a ground plane, the ground plane having a notch therein, at least one parasitic director offset from the ground plane and a driven element formed by a dipole antenna coupled to the ground plane in proximity to the notch and located between the at least one parasitic director and an edge of the ground plane.

Preferably, the notch is generally parallel to the dipole and rearwardly offset therefrom in a direction towards the edge of the ground plane.

Preferably, the notch has a length between a quarter and a half of an operating wavelength of the dipole.

In accordance with a preferred embodiment of the present invention, the ground plane includes a printed circuit board (PCB) ground plane.

Preferably, the ground plane, the at least one director and the dipole are supported by a dielectric surface.

In accordance with another preferred embodiment of the present invention, the ground plane and the director are planar.

Preferably, the dipole is planar. Alternatively, the dipole is non-planar.

In accordance with a further preferred embodiment of the present invention, the antenna also includes a balun formed integrally with the dipole.

Preferably, the dipole includes a first dipole arm and a second dipole arm.

Preferably, the dipole is fed by a feedline.

Preferably, the feedline includes a transmission line, which transmission line is preferably a printed transmission line.

Preferably, the first dipole arm is galvanically connected to the transmission line and the second dipole arm is galvanically connected to the ground plane.

In accordance with yet a further preferred embodiment of the present invention, the feedline includes a coaxial cable including an inner conductor and an outer conductor.

Preferably, the first dipole arm is galvanically connected to the inner conductor and the second dipole arm is galvanically connected to the ground plane.

Additionally or alternatively, the outer conductor is galvanically connected to the ground plane.

Preferably, the at least one director is galvanically connected to the dipole to form a unitary structure.

Preferably, the antenna includes a single metallic sheet.

Preferably, the at least one director includes at least one conductive strip.

Preferably, a peak gain of the antenna is equal to at least about 5 dBi.

In accordance with another preferred embodiment of the present invention, a multiple antenna assembly includes at least two of the antennas and the ground plane includes a common ground plane of the at least two antennas.

Preferably, an isolation between the at least two antennas is better than about −35 dB.

### BRIEF DESCRIPTION OF THE DRAWINGS

The present invention will be understood and appreciated more fully from the following detailed description, taken in conjunction with the drawings in which:

FIGS. 1A and 1B are simplified respective top and perspective views of an antenna constructed and operative in accordance with a preferred embodiment of the present invention;

FIG. 2 is a simplified map showing a surface current distribution of an antenna of the type shown in FIGS. 1A and 1B;

FIG. 3 is a graph showing an H-plane radiation pattern of an antenna of the type shown in FIGS. 1A and 1B;

FIG. 4 is a graph showing an E-plane radiation pattern of an antenna of the type shown in FIGS. 1A and 1B;

FIG. 5 is a graph showing a far-field radiation pattern of an antenna of the type shown in FIGS. 1A and 1B;

FIG. 6 is a graph showing a return loss of an antenna of the type shown in FIGS. 1A and 1B;

FIG. 7 is a simplified view of an antenna constructed and operative in accordance with another preferred embodiment of the present invention;

FIG. 8 is a simplified view of an antenna constructed and operative in accordance with a further preferred embodiment of the present invention;

FIG. 9 is a simplified view of an antenna of the type illustrated in FIG. 8, including an additional director;

FIG. 10 is a simplified view of an antenna constructed and operative in accordance with yet another preferred embodiment of the present invention;

FIG. 11 is a simplified view of an antenna of the type illustrated in FIG. 10, including an additional director;

FIG. 12 is a simplified top view of an antenna assembly including two co-located antennas of the type shown in FIGS. 1A and 1B;

FIG. 13 is a graph showing a return loss and isolation of two co-located antennas of the type shown in FIG. 12;

FIG. 14 is a graph showing a far-field radiation pattern of two co-located antennas of the type shown in FIG. 12;

FIGS. 15A and 15B are graphs showing H-plane radiation patterns of two co-located antennas of the type shown in FIG. 12; and

FIGS. 16A and 16B are graphs showing E-plane radiation patterns of two co-located antennas of the type shown in FIG. 12.

### DETAILED DESCRIPTION OF PREFERRED EMBODIMENTS

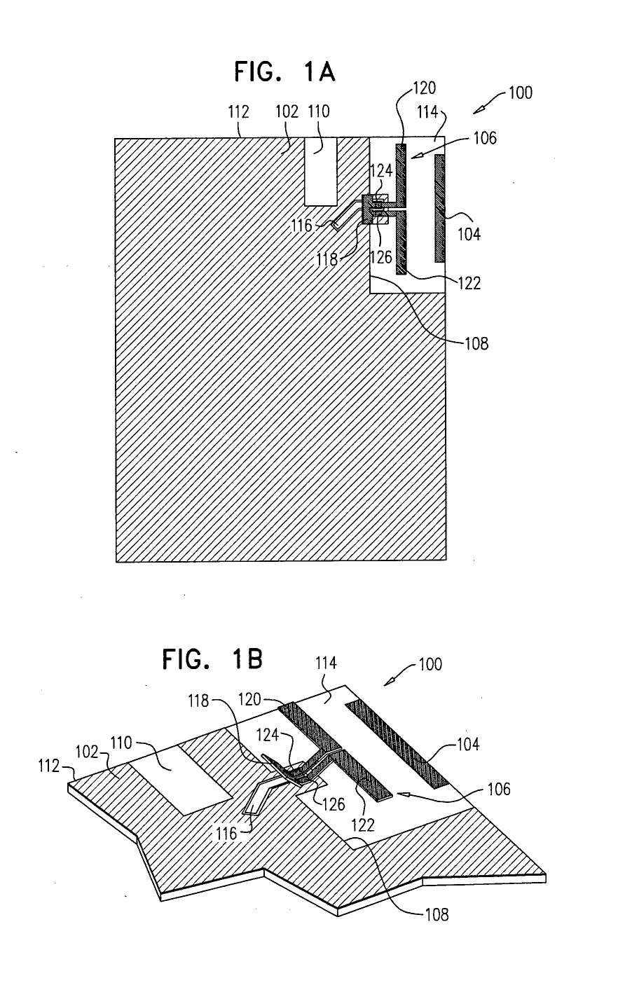

Reference is now made to FIGS. 1A and 1B, which are simplified respective top and perspective views of an antenna constructed and operative in accordance with a preferred embodiment of the present invention.

As seen in FIGS. 1A and 1B, there is provided an antenna 100. Antenna 100 preferably includes a reflector, in the form of a ground plane 102 and at least one parasitic director, here including a parasitic director 104, offset from ground plane 102. Antenna 100 further includes a driven element, in the form of a dipole antenna 106, coupled to ground plane 102 and preferably located between director 104 and an edge 108 of ground plane 102.

It is appreciated by one skilled in the art that antenna 100, including reflector 102, at least one parasitic director 104 and driven element 106, somewhat resembles a Yagi-Uda type antenna. Antenna 100 differs from conventional Yagi-Uda type antennas in that the reflector, formed by the ground plane 102, has an electrical length substantially greater than the typical Yagi-Uda reflector length of approximately half a wavelength of the operating wavelength of the antenna.

It is a particular feature of the antenna of the present invention that a notch 110 is formed in ground plane 102, which notch 110 preferably extends inwards from an upper edge 112 of the ground plane 102. Notch 110 is preferably generally parallel to dipole 106 and rearwardly offset with respect thereto, in a direction towards edge 108 and away from director 104. Notch 110 preferably has a length between about a quarter and a half of an operating wavelength of the dipole 106 and a width between about a quarter and a half of its own length. Notch 110 serves to improve the directivity and isolation of dipole 106, as will be explained in greater detail below.

Ground plane 102 is preferably a printed circuit board (PCB) ground plane, although it is appreciated that ground plane 102 may be formed of any suitable conductor. Ground plane 102, director 104 and dipole 106 are preferably supported by a dielectric surface 114. Dielectric surface 114 may be a layer of a PCB, air, or any other material having suitable dielectric properties. As seen most clearly in FIG. 1B, dipole 106 is preferably a non-planar element, preferably disposed generally parallel to and above ground plane 102. Director 104 is preferably a planar strip of conductive material, which may be printed, plated or otherwise attached to supporting surface 114.

Dipole 106 is preferably fed by a feedline, such as a transmission line 116. A non-planar balun section 118 is preferably formed integrally with dipole 106 in order to improve the impedance match of dipole 106 to transmission line 116. In the absence of balun 118 the low input impedance of dipole 106 would be poorly matched to the typical 50 Ohm impedance of conventional transmission lines, leading to degradation in both the efficiency and bandwidth of antenna 100.

Dipole 106 is preferably a half-wavelength dipole, preferably including respective first and second co-linear quarter-wavelength arms 120 and 122, electrically connected to and contiguous with balun 118. It is appreciated that although dipole 106 and balun 118 are distinguished between herein for the purpose of description of their different functions, dipole 106 and balun 118 are preferably formed as a monolithic structure.

As seen most clearly in FIG. 1A, first dipole arm 120 is preferably connected to transmission line 116 at a feed point 124 and second dipole arm 122 is preferably connected to the ground plane 102 at a grounding point 126. Feed point 124 and grounding point 126 are preferably located between first and second dipole arms 120 and 122 and balun 118.

In operation of antenna 100, dipole 106 is excited at feed point 124 by a radio-frequency signal conveyed by transmission line 116. Ground plane 102 and director 104 act as parasitic elements, re-radiating power received from the dipole 106 and thereby increasing the directivity of antenna 100 in a direction forward from the dipole 106 towards the director 104, along an axis perpendicular to dipole 106. It is appreciated by those skilled in the art that the operation of antenna 100 described so far thus generally resembles the typical operation of a directive Yagi-Uda antenna.

However, were it not for the provision of notch 110, surface currents induced on upper edge 112 of ground plane 102 by dipole 106 would be dispersed along the upper edge 112 away from dipole 106. These dispersed surface currents would tend to adversely affect the directivity of antenna 100 by causing power to be undesirably radiated in a direction rearward, rather than forward, of dipole 106. The presence of notch 110 creates a discontinuity in ground plane 102, causing the induced surface currents traveling along the upper edge 112 of the ground plane 102 to be concentrated around notch 110. As a result, notch 110 effectively acts as a coupled slot antenna and tends to radiate, whereby the directivity of antenna 100 is improved.

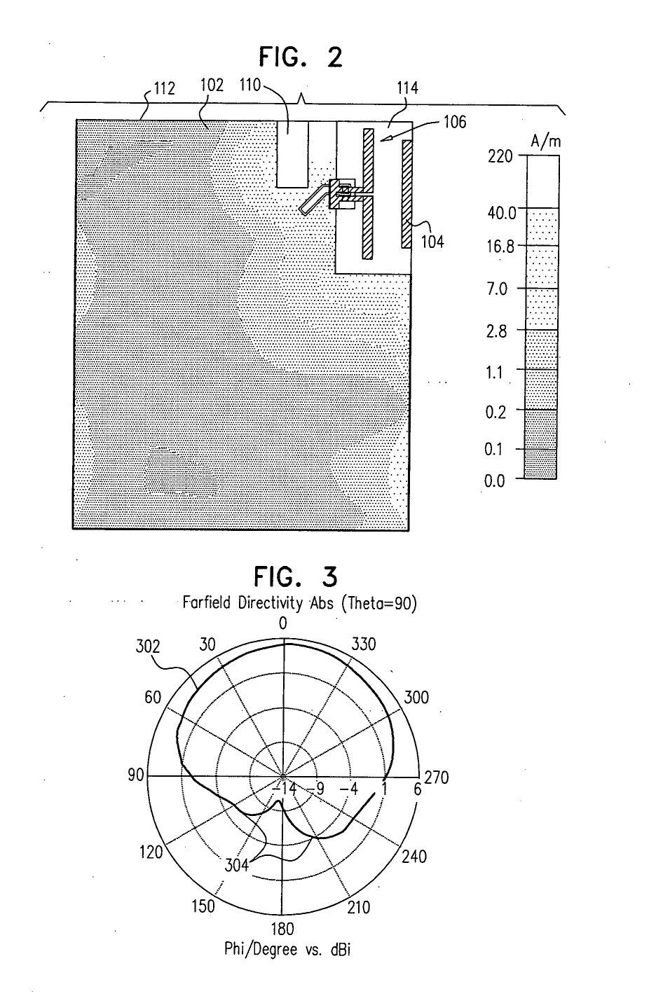

The effect of notch 110 on the distribution of surface currents on ground plane 102 is best appreciated from consideration of FIG. 2.

Reference is now made to FIG. 2, which is a simplified map showing a surface current distribution of an antenna of the type shown in FIGS. 1A and 1B.

As seen in FIG. 2, surface currents induced along upper edge 112 of ground plane 102 are choked off by notch 110 and thus confined to a region of ground plane 102 proximal to dipole 106. This minimizes the amount of power that is undesirably radiated by ground plane 102 in a direction rearward of dipole 106 and thereby improves the directivity of antenna 100. In the absence of notch 110, surface currents would continue to travel along upper edge 112 into the region of ground plane 102 beyond notch 110, thereby dispersing power in a direction rearward of dipole 106 and reducing the directivity of the antenna.

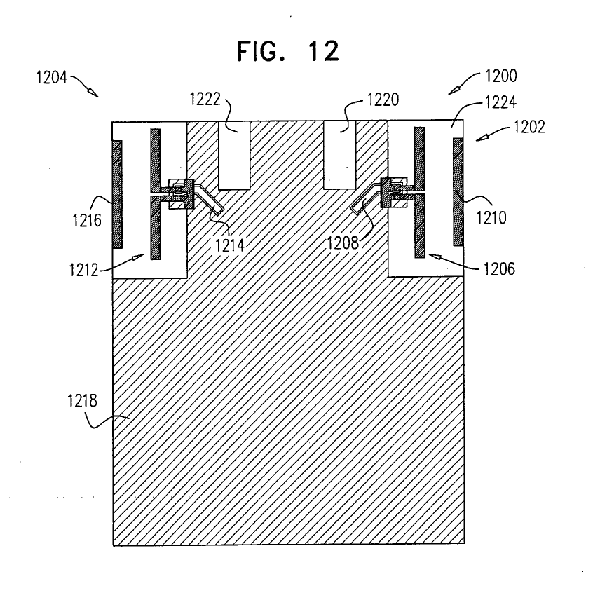

In addition to reducing directivity of antenna 100, these surface currents would also tend to cause undesirable coupling between multiple antennas that may be co-located on ground plane 102. As a result of notch 110 choking off surface currents, isolation between multiple antennas sharing ground plane 102 is improved, as will be explained in greater detail in reference to FIGS. 12-16 below.

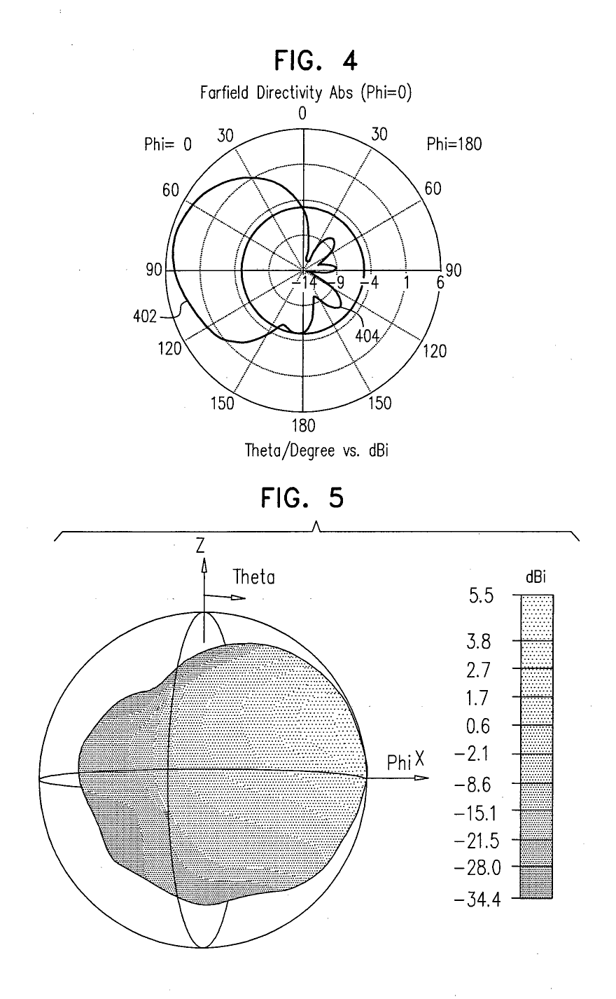

Antenna 100 radiates predominantly in one direction, as indicated by main lobes 302 and 402 respectively illustrated in the H- and E-plane radiation patterns of antenna 100, respectively shown in FIGS. 3 and 4. As seen in FIGS. 3 and 4, only limited power is radiated by antenna 100 in the direction of back lobes 304 and 404. Antenna 100 may have a peak gain of about 5.57 dBi at 2.6 GHz, as shown in FIG. 5.

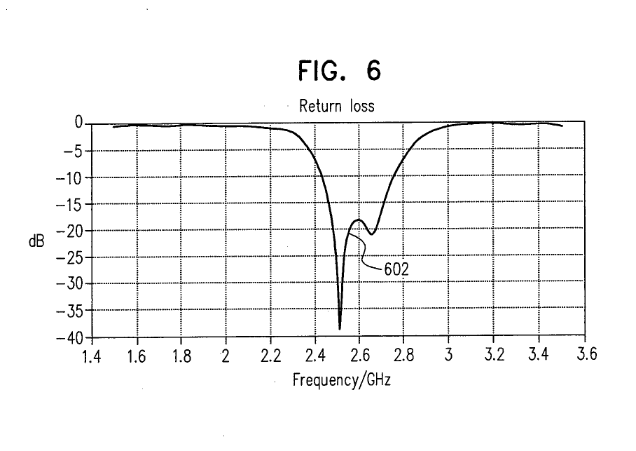

In addition to the presence of notch 110 improving the directivity and isolation of antenna 100, notch 110 also serves to advantageously widen the operating bandwidth of antenna 100, as is indicated by a broad local minima 602 of the return loss graph of antenna 100, shown in FIG. 6. The enhanced bandwidth of antenna 100 is attributed to the resonant length of notch 110, leading to dipole 106 and notch 110 radiating over a broad range of frequencies.

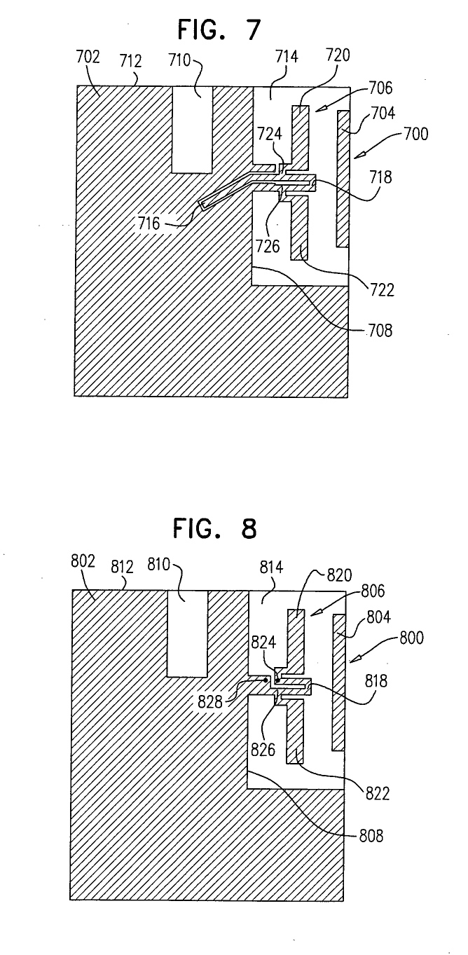

Reference is now made to FIG. 7, which is a simplified view of an antenna constructed and operative in accordance with another preferred embodiment of the present invention.

As seen in FIG. 7, there is provided an antenna 700 including a ground plane 702, at least one parasitic director, here including a parasitic director 704, and a dipole 706 preferably located between director 704 and an edge 708 of ground plane 702. A notch 710 is preferably formed in ground plane 702, extending inwards from an upper edge 712 of ground plane 702 and offset from dipole 706. Ground plane 702, director 704 and dipole 706 are preferably located on a dielectric supporting surface 714. Director 704 is preferably a planar strip of conductive material, which may be printed, plated or otherwise attached to supporting surface 714.

Antenna 700 is preferably fed by a printed transmission line 716, such as a co-planar waveguide, having an impedance of the order of 50 Ohms. Transmission line 716 is matched to dipole 706, which has an input impedance much lower than 50 Ohms, by means of a balun 718, which balun 718 is preferably integrated into dipole 706.

Dipole 706 is preferably a half-wavelength dipole and preferably includes first and second quarter wavelength dipole arms 720 and 722. Dipole arms 720 and 722 are preferably contiguous with and electrically connected to balun 718. First dipole arm 720 is preferably connected to transmission line 716 at a feed point 724. Second dipole arm 722 is preferably connected to ground plane 702 at a grounding point 726. Feed point 724 and grounding point 726 are preferably located rearward of dipole 706 and balun 718.

Ground plane 702, director 704, dipole 706, transmission line 716 and balun 718 are preferably formed as printed elements on a common surface of carrier 714.

It is appreciated that antenna 700 generally resembles antenna 100 in every relevant respect with the exception of the planar nature of dipole 706 and balun 718, in contrast to the non-planar configuration of dipole 106 and balun 118 in antenna 100, and with the exception of the placement of the balun. Whereas in antenna 100 balun 118 extends rearward of dipole 106, in the direction of ground plane 102, in antenna 700 balun 718 extends forward of dipole 706, in the direction of director 704. In antenna 700, feed and grounding points 724 and 726 are hence preferably located rearward of both balun 718 and dipole 706, rather than between the balun and dipole, as in antenna 100.

Antenna 700 shares other features and advantages described above in reference to antenna 100, including improved directivity and isolation and widened bandwidth due to the presence of notch 710.

Reference is now made to FIG. 8, which is a simplified view of an antenna constructed and operative in accordance with a further preferred embodiment of the present invention.

As seen in FIG. 8, there is provided an antenna 800 including a ground plane 802, at least one parasitic director, here including a parasitic director 804, and a dipole antenna 806 preferably located between director 804 and an edge 808 of ground plane 802. A notch 810 is preferably formed in ground plane 802, extending inwards from an upper edge 812 of ground plane 802 and offset from dipole 806. Ground plane 802, director 804 and dipole 806 are preferably located on a dielectric supporting surface 814.

Antenna 800 is preferably fed by a coaxial cable (not shown) which is impedance matched to dipole 806 by means of a balun 818, which balun 818 is integrated into dipole 806.

Dipole 806 is preferably a half-wavelength dipole and preferably includes first and second quarter wavelength dipole arms 820 and 822. Dipole arms 820 and 822 are preferably contiguous with and electrically connected to balun 818. First dipole arm 820 is preferably connected to an inner conductor of the coaxial cable at a feed point 824. Second dipole arm 822 is preferably connected to ground plane 802 at a grounding point 826. An outer conductor of the coaxial cable is preferably connected to the ground plane 802 at a connection point 828. Feed point 824 and grounding point 826 are preferably located rearward of dipole 806 and balun 818.

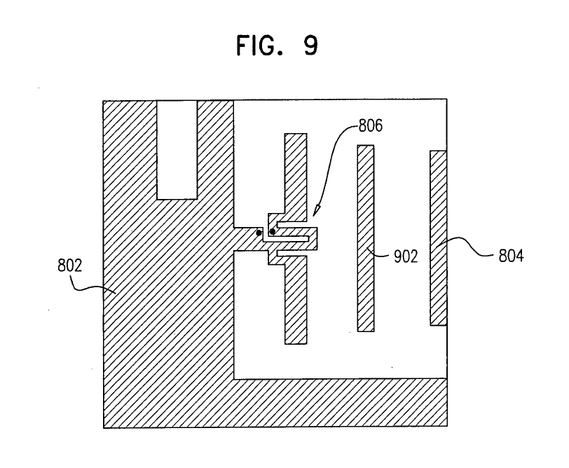

Ground plane 802, director 804 and dipole 806 are preferably planar, optionally printed conductive elements. It is appreciated that, in order to improve its directivity, additional directors, such as conductive element 902 shown in FIG. 9, may optionally be incorporated into antenna 800.

It is appreciated that antenna 800 generally resembles antenna 700 in every relevant respect with the exception of its feedline structure. Whereas antenna 700 is fed by a printed transmission line, antenna 800 is fed by a coaxial cable. Antenna 800 is thus particularly well suited for use in radio systems where the radio unit is located far from the antenna, due to the lower transmission losses of coaxial cables in comparison to those of long printed transmission lines.

Antenna 800 shares other features and advantages described above in reference to antennas 100 and 700, including improved directivity and isolation and widened bandwidth due to the presence of notch 810.

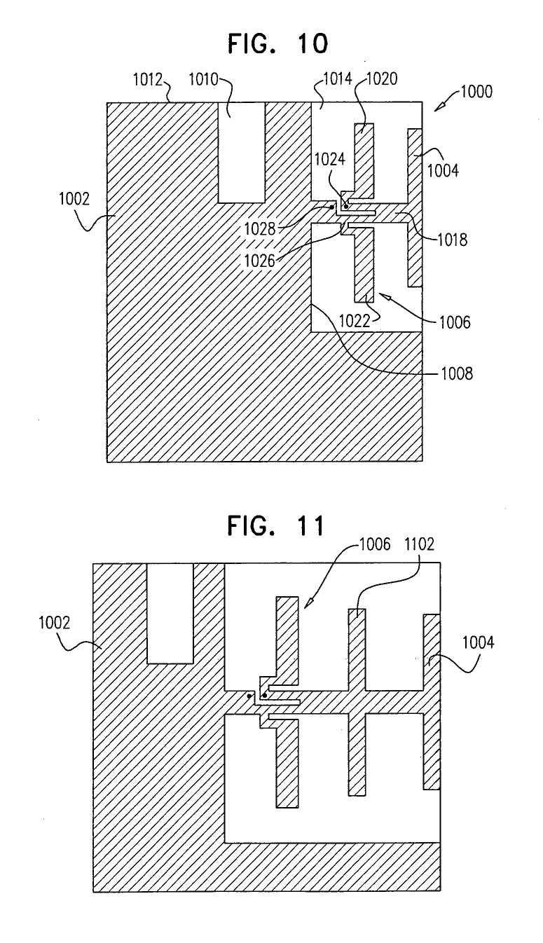

Reference is now made to FIG. 10, which is a simplified top view of an antenna constructed and operative in accordance with yet another preferred embodiment of the present invention.

As seen in FIG. 10, there is provided an antenna 1000 including a ground plane 1002, at least one parasitic director, here including a parasitic director 1004, and a dipole 1006 preferably located between director 1004 and an edge 1008 of ground plane 1002. A notch 1010 is preferably formed in ground plane 1002, extending inwards from an upper edge 1012 of ground plane 1002 and offset from dipole 1006. Ground plane 1002, director 1004 and dipole 1006 are preferably located on a dielectric supporting surface 1014. Ground plane 1002, director 1004 and dipole 1006 and are preferably planar, optionally printed, conductive elements.

Antenna 1000 is preferably fed by a coaxial cable (not shown) which is impedance matched to dipole 1006 by means of a balun 1018, which balun 1018 is integrated into dipole 1006. It is appreciated that antenna 1000 is illustrated as being fed by a coaxial cable by way of example only and that antenna 1000 may alternatively be fed by any other suitable feedline, including a transmission line as described above in reference to antennas 100 and 700.

It is a particular feature of antenna 1000 that balun 1018 preferably has an extended structure, by way of which extended balun structure 1018 director 1004 is preferably galvanically connected to dipole 1006. Due to its unitary design, antenna 1000 may be constructed of a single thin sheet of metal and directly attached to the interior plastic wall of a wireless communication device, whereby supporting surface 1014 may be obviated.

It is appreciated that, in order to improve its directivity, additional directors, such as conductive element 1102 shown in FIG. 11, may be incorporated into antenna 1000 and may be connected both to balun 1018 and director 1004.

Dipole 1006 is preferably a half-wavelength dipole and preferably includes first and second quarter wavelength dipole arms 1020 and 1022. Dipole arms 1020 and 1022 are preferably contiguous with and electrically connected to balun 1018. First dipole arm 1020 is preferably connected to an inner conductor of the coaxial cable at a feed point 1024. Second dipole arm 1022 is preferably connected to ground plane 1002 at a grounding point 1026. An outer conductor of the coaxial cable is preferably connected to the ground plane 1002 at a connection point 1028. Feed point 1024 and grounding point 1026 are preferably located rearward of dipole 1006 and balun 1018.

It is appreciated that antenna 1000 generally resembles antenna 800 in every relevant respect with the exception of its unitary design. Antenna 1000 shares other features and advantages described above in reference to antenna 800, including improved directivity and isolation and widened bandwidth due to the presence of notch 1010.

Reference is now made to FIG. 12, which is a simplified top view of an antenna assembly including two co-located antennas of the type shown in FIGS. 1A and 1B.

As seen in FIG. 12, there is provided an antenna assembly 1200 including at least two antennas, here shown, by way of example, as antennas 1202 and 1204. Each of antennas 1202 and 1204 is preferably constructed and operative according to the embodiment of the invention described above in reference to antenna 100 of FIGS. 1A and 1B. Antenna 1202 thus preferably includes a dipole 1206, a printed transmission feedline 1208 and a conductive director 1210 and antenna 1204 preferably includes a dipole 1212, a printed transmission feedline 1214 and a conductive director 1216. Antennas 1202 and 1204 are each preferably coupled to a common ground plane 1218.

Antenna 1202 is preferably located adjacent to notch 1220 formed in common ground plane 1218 and antenna 1204 is preferably located adjacent to notch 1222 formed in common ground plane 1218. Antennas 1202 and 1204 and ground plane 1218 are preferably supported by a common dielectric surface 1224.

The presence of notches 1220 and 1222 serves to choke off surface currents induced along an upper edge of common ground plane 1218, which surface currents would otherwise cause undesirable coupling between antennas 1202 and 1204.

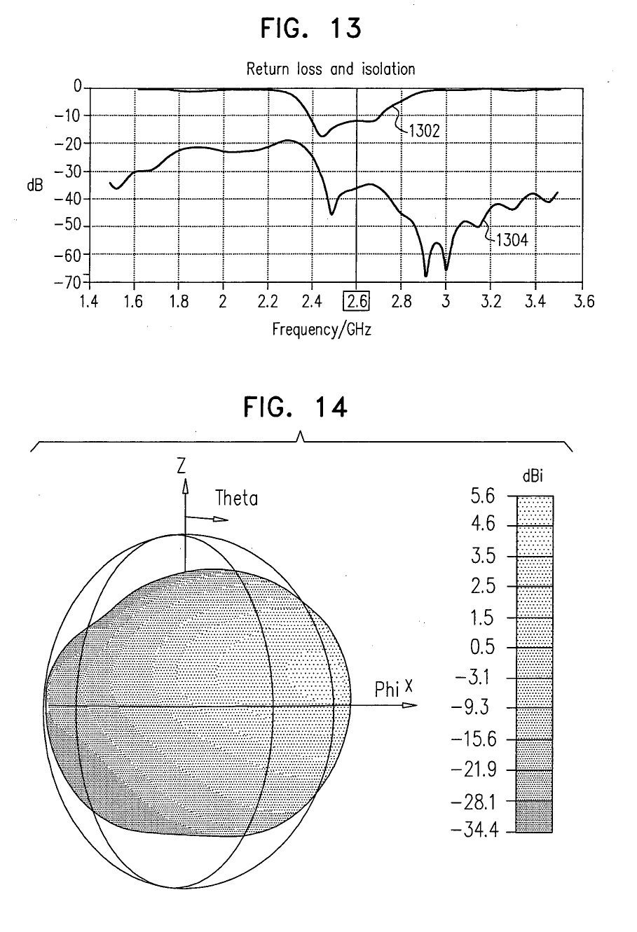

Reference is now made to FIG. 13, which is a graph showing the return loss and isolation of two co-located antennas of the type shown in FIG. 12.

As seen in FIG. 13, the operating bandwidth of each of the antennas, which may be inferred from a line 1302, is centered on a resonant frequency of approximately 2.6 GHz. The isolation between the antennas, plotted by a line 1304, is seen to be better than −36 dB at 2.6 GHz. This high isolation between antennas 1202 and 1204 reduces the need for filters on the PCB, which filters would otherwise be required in order to minimize coupling between the two antennas. Antennas 1202 and 1204 may each have a peak gain of about 5.6 dBi at 2.6 GHz, as seen in FIG. 14.

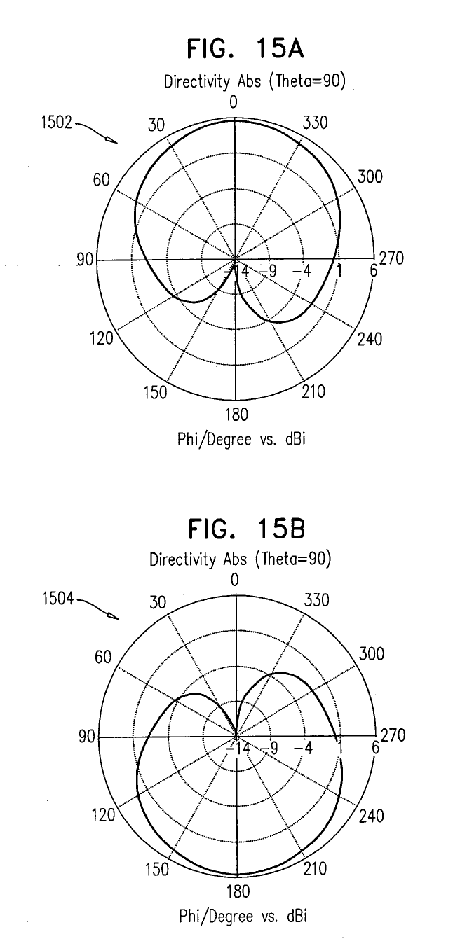

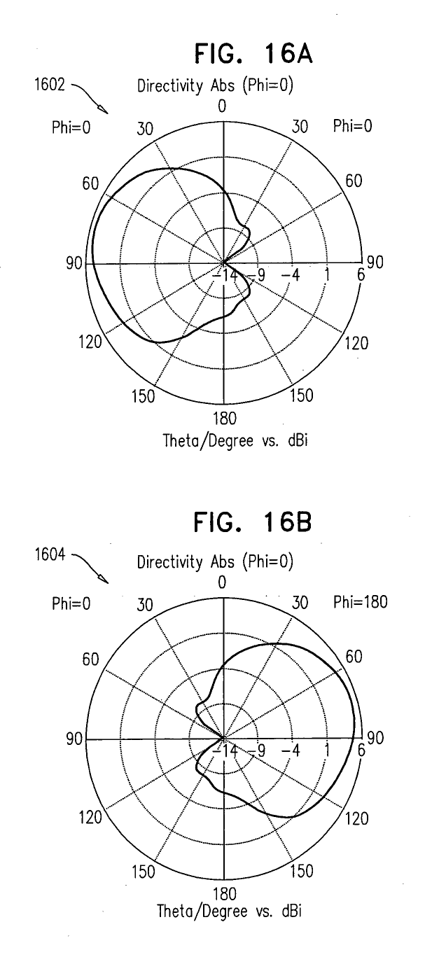

Reference is now made to FIGS. 15A-16B, which are graphs respectively showing H-plane and E-plane radiation patterns of two co-located antennas of the type shown in FIG. 12.

As seen in FIGS. 15A and 15B, the H-plane radiation patterns of antennas 1202 and 1204 are respectively represented by plots 1502 and 1504. As seen in FIGS. 16A and 16B, the E-plane radiation patterns of antennas 1202 and 1204 are respectively represented by plots 1602 and 1604. As is apparent from these plots, antennas 1202 and 1204 remain highly directional despite their co-location on ground plane 1218.

It is appreciated that although only two antennas, namely antenna 1202 and antenna 1204, are illustrated in FIG. 12, the inclusion of a greater number of antennas on common ground plane 1218 is also possible due to their improved mutual isolation. It is further appreciated that two or more antennas of any of the types of antennas described herein, including any of antennas 700-1100, may be co-located on a common ground plane.

It will be appreciated by persons skilled in the art that the present invention is not limited by what has been particularly claimed hereinbelow. Rather, the scope of the invention includes various combinations and subcombinations of the features described hereinabove as well as modifications and variations thereof as would occur to persons skilled in the art upon reading the forgoing description with reference to the drawings and which are not in the prior art.

1.-24. (canceled)

25. An antenna comprising:
a reflector formed by a ground plane, said ground plane having a notch therein, said notch being adapted to operate as a coupled slot antenna and thereby to choke off surface currents on said ground plane; and
a driven element formed by a dipole antenna coupled to said ground plane in proximity to said notch.

26. An antenna according to claim 25, and also comprising at least one parasitic director offset from said ground plane, said notch being located between said at least one parasitic director and an edge of said ground plane.

27. An antenna according to claim 25, wherein said notch is generally parallel to said dipole and rearwardly offset therefrom in a direction towards said edge of said ground plane.

28. An antenna according to claim 25, wherein said notch has a length between a quarter and a half of an operating wavelength of said dipole.

29. An antenna according to claim 25, wherein said ground plane comprises a printed circuit board (PCB) ground plane.

30. An antenna according to claim 25, wherein said ground plane, said at least one director and said dipole are supported by a dielectric surface.

31. An antenna according to claim 25, wherein said ground plane and said director are planar.

32. An antenna according to claim 31, wherein said dipole is planar.

33. An antenna according to claim 31, wherein said dipole is non-planar.

34. An antenna according to claim 25, and also comprising a balun formed integrally with said dipole.

35. An antenna according to claim 25, wherein said dipole comprises a first dipole arm and a second dipole arm.

36. An antenna according to claim 35, wherein said dipole is fed by a feedline.

37. An antenna according to claim 36, wherein said feedline comprises a transmission line.

38. An antenna according to claim 37, wherein said transmission line comprises a printed transmission line.

39. An antenna according to claim 37, wherein said first dipole arm is galvanically connected to said transmission line and said second dipole arm is galvanically connected to said ground plane.

40. An antenna according to claim 36, wherein said feedline comprises a coaxial cable comprising an inner conductor and an outer conductor.

41. An antenna according to claim 40, wherein said first dipole arm is galvanically connected to said inner conductor and said second dipole arm is galvanically connected to said ground plane.

42. An antenna according to claim 40, wherein said outer conductor is galvanically connected to said ground plane.

43. An antenna according to claim 25, wherein said at least one director is galvanically connected to said dipole to form a unitary structure.

44. An antenna according to claim 43, wherein said antenna comprises a single metallic sheet.

45. An antenna according to claim 25, wherein said at least one director comprises at least one conductive strip.

46. An antenna according to claim 25, wherein a peak gain of said antenna is equal to at least about 5 dBi.

47. A multiple antenna assembly comprising at least two of said antennas of claim 25, wherein said ground plane comprises a common ground plane of said at least two antennas.

48. A multiple antenna assembly according to claim 47, wherein an isolation between said at least two antennas is better than about −35 dB.
